(19) United States
(12) Patent Application Publication
(10) Pub. No.: US 2026/0302361 A1
(43) Pub. Date: Oct. 1, 2026

(54) SECONDARY BATTERY

(71) Applicant: TOYOTA JIDOSHA KABUSHIKI KAISHA, Toyota-shi (JP)

(72) Inventor: Takuya SUGIMOTO, Toyota-shi (JP)

(73) Assignee: TOYOTA JIDOSHA KABUSHIKI KAISHA, Toyota-shi (JP)

(21) Appl. No.: 19/542,756

(22) Filed: Feb. 18, 2026

(30) Foreign Application Priority Data
Mar. 26, 2025 (JP) 2025-051582

(51) Int. Cl. H01M 10/0585; H01M 4/36; H01M 4/70

(52) U.S. Cl. CPC H01M 10/0585; H01M 4/366; H01M 4/70; H01M 2300/0065

(57) ABSTRACT

A secondary battery includes a separator, on which a composite material layer, a collector foil, and a resin layer are laminated, in which the resin layer includes at least a first resin and a second resin that are arranged in a direction along a layer surface, the first resin and the second resin having different melting points.

### CROSS-REFERENCE TO RELATED APPLICATION

This application claims priority to Japanese Patent Application No. 2025-051582 filed on Mar. 26, 2025. The disclosure of the above-identified application, including the specification, drawings, and claims, is incorporated by reference herein in its entirety.

### BACKGROUND

### 1. Technical Field

The present disclosure relates to a secondary battery.

### 2. Description of Related Art

Japanese Unexamined Patent Application Publication No. 2021-170486 (JP 2021-170486 A) discloses that, in a battery, a spacer 14 having a rectangular frame shape is disposed at a peripheral edge portion 22c of a collector 22. A bonding region K between the collector 22 and the spacer 14 is formed in a frame shape at an overlapping portion of the spacer 14 having a rectangular frame shape in the peripheral edge portion 22c of the collector 22. A fragile portion Ka having a lower bonding strength between the spacer 14 and the collector 22 than other portions of the bonding region K is provided in the bonding region K (paragraph [0029]).

### SUMMARY

In the related art, since the fragile portion is provided at the peripheral portion of the collector, it is not possible to deal with a case where gas is generated in a central portion of the battery. In a case where such gas is generated, the resistance may increase and the temperature may rise.

The present disclosure has been made in view of the above problem, and an object thereof is to provide a secondary battery capable of reducing a temperature rise.

The present application discloses a secondary battery including a separator, on which a composite material layer, a collector foil, and a resin layer are laminated, in which the resin layer includes at least a first resin and a second resin that are arranged in a direction along a layer surface, the first resin and the second resin having different melting points.

A difference in melting points between the first resin and the second resin may be 20° C. or more.

A width of the first resin and the second resin may be 10 cm or less.

In a case where one separator, positive electrode and negative electrode composite material layers, positive electrode and negative electrode collector foils, and positive electrode and negative electrode resin layers are laminated to serve as a unit laminate, a capacity per unit laminate may be 3 Ah or more.

According to the secondary battery of the present disclosure, even in a case where gas is generated at a high temperature, the resistance is suppressed from increasing, and the temperature rise can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a laminated structure of a secondary battery 10;

FIG. 2A is a diagram illustrating an action of a secondary battery in related art; and

FIG. 2B is a diagram illustrating an action of the secondary battery 10.

### DETAILED DESCRIPTION OF EMBODIMENTS

### 1. Structure of Secondary Battery

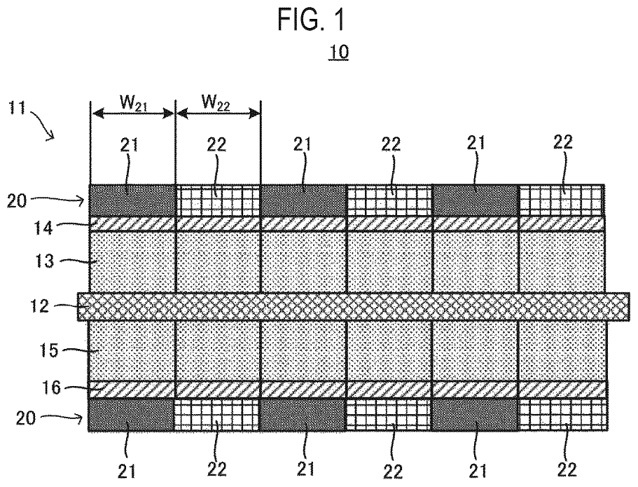

FIG. 1 schematically shows a secondary battery 10 according to one form example. FIG. 1 is a diagram illustrating a laminated structure of a secondary battery. In FIG. 1, for convenience of description, configurations necessary for the description are shown, and a battery case and the like are omitted. Here, the secondary battery means any of an all-solid state battery in which an electrolyte consists of a solid electrolyte, a semi-solid state battery in which at least a part of the electrolyte is a solid electrolyte and also includes an electrolytic solution, or a battery including only an electrolytic solution. Hereinafter, the form example will be described by using the all-solid state battery.

As can be seen from FIG. 1, the secondary battery 10 includes a unit laminate 11 as one unit battery, and a plurality of the unit laminates 11 are laminated to be repeated. The unit laminate 11 includes a separator 12, a positive electrode composite material layer 13 is laminated on a first surface of the separator 12, a positive electrode collector foil 14 is laminated on the positive electrode composite material layer 13, and a resin layer 20 is further laminated. A negative electrode composite material layer 15 is laminated on a second surface of the separator 12, a negative electrode collector foil 16 is laminated on the negative electrode composite material layer 15, and a resin layer 20 is further laminated. Each layer will be described below.

### 1.1. Separator

The separator 12 is a layer including at least an electrolyte. In a case where the secondary battery 10 is the all-solid state battery, the separator 12 can include a solid electrolyte and optionally a binder. An inorganic solid electrolyte described later can be applied as the solid electrolyte. A binder can be appropriately selected and used as the same binder as the binder used in the positive electrode composite material layer 15 described later. The materials in the separator 12 and the shape of the separator 12 may be the same as those in the related art. In particular, from the viewpoint of easily configuring the secondary battery 10, a separator 12 having a sheet shape is preferable. In this case, a thickness of the separator 12 is, for example, preferably 0.1 μm to 1 mm and more preferably 1 μm to 100 μm. Still More preferably, the thickness of the separator 12 is 1 μm to 15 μm.

### 1.2. Positive Electrode Composite Material Layer

The positive electrode composite material layer 13 is at least a layer including a positive electrode active material. In a case where the secondary battery 10 is the all-solid state battery, a solid electrolyte, a binder, a conductive auxiliary agent, and the like can be optionally included in addition to the positive electrode active material.

A known active material may be used as the positive electrode active material. Among known active materials, two materials having different potentials (charge and discharge potentials) at which predetermined ions are intercalated and deintercalated can be selected, and a material showing a higher potential can be used as a positive electrode active material, and a material showing a lower potential can be used as a negative electrode active material described later. For example, in a case of constituting a lithium ion battery, various lithium-containing complex oxides such as lithium cobalt oxide, lithium nickelate, LiNi_{1/3}Co_{1/3}Mn_{1/3}O₂, lithium manganese oxide, and a spinel-based lithium compound can be used as the positive electrode active material.

The surface of the positive electrode active material may be coated with an oxide layer such as a lithium niobate layer, a lithium titanate layer, or a lithium phosphate layer.

The solid electrolyte is preferably an inorganic solid electrolyte. The reason for the above is that the inorganic solid electrolyte has higher ionic conductivity and superior heat resistance compared to an organic polymer electrolyte. Examples of the inorganic solid electrolyte include an oxide solid electrolyte such as lanthanum zirconate lithium, and a sulfide solid electrolyte such as Li₂S—P₂S₅. In particular, a sulfide solid electrolyte including Li₂S—P₂S₅ is preferable, and a sulfide solid electrolyte including 50% by mole or more of Li₂S—P₂S₅ is more preferable.

As the binder, various binders such as butadiene rubber (BR), styrene butadiene rubber (SBR), acrylate butadiene rubber (ABR), and polyvinylidene fluoride (PVdF) can be used. As the conductive auxiliary agent, a carbon material such as acetylene black or Ketjen black, or a metal material such as nickel, aluminum, or stainless steel can be used.

The content of each component in the positive electrode composite material layer 13 may be the same as that in the related art. In addition, from the viewpoint of easily constituting the secondary battery 10, a positive electrode composite material layer 13 having a sheet shape is preferable. In this case, a thickness of the positive electrode composite material layer 15 is, for example, preferably 0.1 μm to 1 mm and more preferably 1 μm to 150 μm.

In addition, in the present form, the positive electrode composite material layer 13 is divided according to a division mode of the resin layer 20 (arrangement of the first resin 21 and the second resin 22) described later. A specific divided aspect is along the resin layer 20 and will be described later.

### 1.3. Negative Electrode Composite Material Layer

The negative electrode composite material layer 15 is at least a layer including a negative electrode active material. In a case where the secondary battery 10 is the all-solid state battery, a solid electrolyte, a binder, a conductive auxiliary agent, and the like can be optionally included in addition to the negative electrode active material. A known active material may be used as the active material. Among known active materials, two materials having different potentials (charge and discharge potentials) at which predetermined ions are intercalated and deintercalated can be selected, and a material showing a higher potential can be used as the positive electrode active material, and a material showing a lower potential can be used as the negative electrode active material. In a case of constituting a lithium ion battery, a carbon material such as graphite or hard carbon, various oxides such as lithium titanate, Si or a Si alloy, or metal lithium or a lithium alloy can be used as the negative electrode active material.

The solid electrolyte, the binder, and the conductive auxiliary agent can be appropriately selected and used as the same as those in the positive electrode composite material layer 13.

The content of each component in the negative electrode composite material layer 15 may be the same as that in the related art. In particular, from the viewpoint of easily constituting the secondary battery 10, a negative electrode composite material layer 15 having a sheet shape is preferable. In this case, a thickness of the negative electrode composite material layer 15 is, for example, preferably 0.1 μm to 1 mm and more preferably 1 μm to 100 μm. However, it is preferable that the thickness of the negative electrode 20 composite material layer 15 is determined such that a capacity of the negative electrode is larger than a capacity of the positive electrode.

In addition, in the present form, the negative electrode composite material layer 15 is divided according to a divided aspect of the resin layer 20 (arrangement of the first resin 21 and the second resin 22) described later. A specific divided aspect is along the resin layer 20 and will be described later.

### 1.4. Positive Electrode Collector Foil

The positive electrode collector foil 14 is a conductive layer. Therefore, the positive electrode collector foil 14 is formed of a metal foil, a metal mesh, or the like. Among these, a metal foil is particularly preferable. Examples of the metal constituting the positive electrode collector foil 14 include Ni, Cr, Au, Pt, Al, Fe, Ti, Zn, an alloy thereof, and stainless steel. The positive electrode collector foil 14 may have a coating layer for adjusting an electric resistance on a surface thereof. For example, the coating layer is a carbon coating.

A thickness of the positive electrode collector foil 14 is not particularly limited, but is, for example, preferably 0.1 μm to 1 mm and more preferably 1 μm to 100 μm.

In addition, in the present form, the positive electrode collector foil 14 is divided according to a divided aspect of the resin layer 20 (arrangement of the first resin 21 and the second resin 22) described later. A specific divided aspect is along the resin layer 20 and will be described later.

### 1.5. Negative Electrode Collector Foil

The negative electrode collector foil 16 is a foil having a collecting action, which is formed of a metal foil, a metal mesh, or the like. In particular, a metal foil is preferable. Examples of the metal constituting the negative electrode collector foil 16 include Cu, Ni, Fe, Ti, Co, Zn, and stainless steel. The negative electrode collector foil 16 may have a coating layer for adjusting a contact resistance on a surface thereof. For example, the coating layer is a carbon coating. A thickness of the negative electrode collector foil 16 is not particularly limited. For example, the thickness is preferably 0.1 μm to 1 mm and more preferably 1 μm to 100 μm.

In addition, in the present form, the negative electrode collector foil 16 is divided according to a divided aspect of the resin layer 20 (arrangement of the first resin 21 and the second resin 22) described later. A specific divided aspect is along the resin layer 20 and will be described later.

### 1.6. Resin Layer

The resin layer 20 is a layer formed of a resin. In order to impart conductivity to the resin layer, a filler of a metal such as Ni may be dispersed in the resin. In the present form, in the resin layer 20, different resins are alternately disposed in one direction (in the left-right direction in FIG. 1) of the layer surface. In the present form, the direction of the layer surface orthogonal to the direction (in the back-front direction in FIG. 1) is continuous. That is, in the present form, the first resin 21 and the second resin 22 in a band shape are alternately arranged along the layer surface.

The first resin 21 and the second resin 22 are formed of resins having different materials, and a difference in melting point therebetween is 20° C. or more. Specifically, the first resin 21 can be polyethylene (melting point: 95° C. to 140° C.), and the second resin can be polypropylene (melting point: 160° C. to 180° C.), although the present disclosure is not limited thereto. As a result, as will be described later, it is possible to suppress an increase in cell resistance and a temperature rise by suppressing an opening between layers even in a case of gas generation.

A width of the first resin 21 (a size in a direction in which the first resin 21 and the second resin 22 are alternately arranged) indicated by W₂₁ in FIG. 1 and a width of the second resin 22 indicated by W₂₂ may be the same. The widths thereof may be different from each other, but are preferably the same. In addition, it is preferable that both the width W₂₁ and the width W₂₂ are 2 cm or more and 10 cm or less.

In the present form, an example in which the first resin 21 and the second resin 22 in a band shape are alternately disposed has been described. The present disclosure is not limited to this, and an arrangement aspect in which the first resin and the second resin are alternately disposed in a lattice shape or alternately disposed in a concentric shape may be adopted.

### 2. Effects and the Like

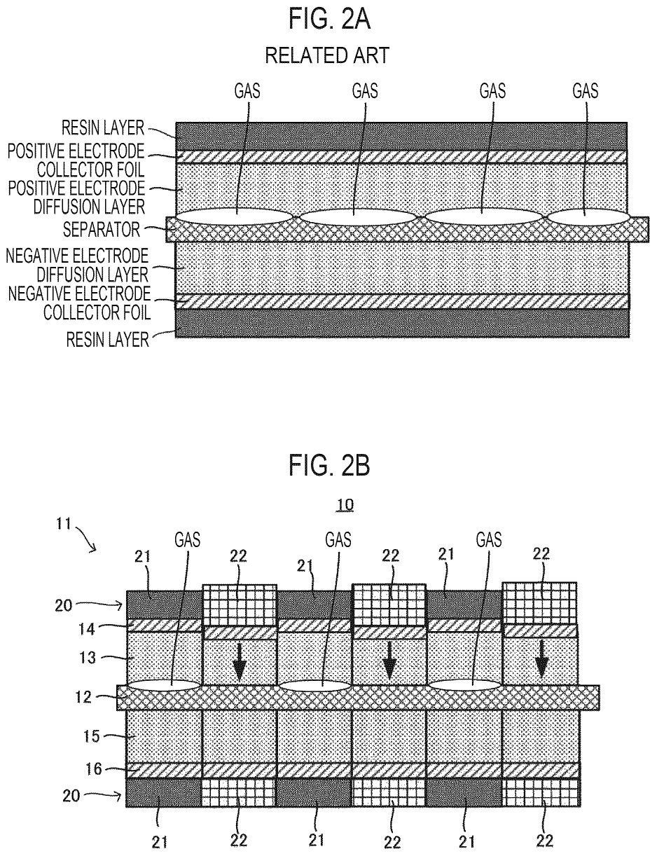

In the related art secondary battery (in which the resin layer is formed of the same material at any position), as shown in FIG. 2A, in a case where gas is generated at a high temperature, the gas remains over a wide range between the layers without being discharged, and the contact between the layers is weakened, which may cause an increase in resistance. The increase in resistance causes an increase in heat generation (temperature rise).

On the other hand, in the secondary battery 10 of the present form, as shown in FIG. 2B, at a high temperature, the second resin 22 having a low melting point expands first to press the layers, and the gas pocket can be divided. Accordingly, since the portion where the contact between the layers in which the gas is generated is weakened is suppressed from spreading, the increase in resistance (that is, heat generation and temperature rise) can be suppressed.

As an aspect in which the gas remains over a wide range as shown in FIG. 2A, a battery having a large area (a battery having a large capacity) is particularly exemplified. Therefore, in a case where the structure of the secondary battery of the present disclosure is applied to a battery having a large capacity in this way, the above-described effects are more remarkable. A specific size is not particularly limited, but a battery having a capacity of 3 Ah or more in the unit laminate 11 (laminate of one separator, positive electrode and negative electrode composite material layers, positive electrode and negative electrode collector foils, and positive electrode and negative electrode resin layers) can be exemplified.

In the above-described form, the positive electrode and the negative electrode resin layers are composed of the first resin 21 and the second resin 22, but only any of the positive electrode or the negative electrode resin layer may be composed of the first resin and the second resin.

In addition, in the above-described form, the composite material layer and the collector foil are divided according to the resin layer, but these may not be divided and may be continuous. Even in a case of being continuous, the effect of the expansion of the resin is exhibited.

### 3. Test Examples

As a test example, a laminate according to each test example was produced, and a temperature rise in a case of being overcharged was measured. Here, as the positive electrode active material of the positive electrode composite material layer, a Ni—Co—Mn-based oxide, as the positive electrode collector foil, an aluminum foil, as the negative electrode active material of the negative electrode composite material layer, carbon, as the negative electrode collector foil, Cu, and as the separator, polyethylene were applied. The layer is one unit laminate. The conditions and results of each test example are as shown in

TABLE 1

| | | | | | Width | Width | Temperature |
|---|---|---|---|---|---|---|---|
| | | Capacity | Resin layer | | W21 | W22 | rise |
| | Form | (Ah) | First resin | Second resin | (cm) | (cm) | (° C.) |
| Test example 1 | FIG. 1 | 3 | Polypropylene | Polyethylene | 10 | 10 | 50 |
| Test example 2 | FIG. 2A | 3 | Polyethylene | | — | | 100 |
| Test example 3 | FIG. 1 | 2 | Polypropylene | Polyethylene | 10 | 10 | 30 |
| Test example 4 | FIG. 2A | 2 | Polyethylene | | — | | 60 |
| Test example 5 | FIG. 1 | 3 | Polypropylene | Polyethylene | 30 | 30 | 70 |

From the comparison between Test Example 1 and Test Example 2 and the comparison between Test Example 3 and Test Example 4, it can be seen that the effect of suppressing the temperature rise by the secondary battery of the present disclosure is exhibited.

The temperature suppression effect of Test Example 1 on Test Example 2 (suppressed from 100° C. to 50° C.) is more remarkable than the temperature suppression effect of Test Example 3 on Test Example 4 (suppressed from 60° C. to 30° C.). As a result, it can be seen that the larger the capacity, the higher the effect.

By comparing Test Example 5 with Test Example 1, it can be seen that the effect is higher in a case where the width of the first resin and the second resin is smaller (10 cm or less).

What is claimed is:

1. A secondary battery comprising a separator, on which a composite material layer, a collector foil, and a resin layer are laminated,
wherein the resin layer includes at least a first resin and a second resin that are arranged in a direction along a layer surface, the first resin and the second resin having different melting points.

2. The secondary battery according to claim 1, wherein a difference in melting points between the first resin and the second resin is 20° C. or more.

3. The secondary battery according to claim 1, wherein a width of the first resin and the second resin is 10 cm or less.

4. The secondary battery according to claim 1, wherein, in a case where one separator, positive electrode and negative electrode composite material layers, positive electrode and negative electrode collector foils, and positive electrode and negative electrode resin layers are laminated to serve as a unit laminate, a capacity per unit laminate is 3 Ah or more.
